(19) United States
(12) Patent Application Publication
(10) Pub. No.: US 2020/0380259 A1
(43) Pub. Date: Dec. 3, 2020

(54) Response to a Real World Gesture in an Augmented Reality Session

(71) Applicant: Microsoft Technology Licensing, LLC, Redmond, WA (US)

(72) Inventors: Jason Matthew CAHILL, Woodinville, WA (US); Torfi Frans OLAFSSON, Kirkland, WA (US); Jesse Dylan MERRIAM, Bothell, WA (US); Timothy James SCHUTZ, Duvall, WA (US); Craig Sean STEYN, Redmond, WA (US); Michael Meincke PERSSON, Redmond, WA (US)

(73) Assignee: Microsoft Technology Licensing, LLC, Redmond, WA (US)

(21) Appl. No.: 16/543,720

(22) Filed: Aug. 19, 2019

Related U.S. Application Data
(60) Provisional application No. 62/856,080, filed on Jun. 2, 2019.

(51) Int. Cl. G06K 9/00; G06F 3/01; G06T 19/00; G06T 13/40

(52) U.S. Cl. CPC G06K 9/00671; G06F 3/017; G06T 13/40; G06K 9/00335; G06T 19/006; G06F 3/011

(57) ABSTRACT

Described herein is a system and method for providing a response (e.g., responsive action of a virtual character) within an augmented reality session. Positional data information regarding at least a portion of a human skeleton is received. A real world gesture is identified based, at least in part, upon the received positional data. A response to the identified real world gesture (e.g., responsive action of the virtual character) is determined based, at least in part upon, the identified real world gesture. The determined response is caused to be performed in the augmented reality session.

### RELATED APPLICATION

This application claims priority to U.S. Provisional Application No. 62/856,080, filed Jun. 2, 2019, entitled “Response to a Real World Gesture in an Augmented Reality Session”, the disclosure of which is hereby incorporated by reference herein in its entirety.

### BACKGROUND

Augmented reality (AR) systems such as video games display real world images overlaid with a virtual experience (e.g., three-dimensional object(s)). An AR system thus enables a participant to view real-world imagery in combination with context-relevant, computer-generated imagery (e.g., virtual object(s) such as virtual character(s)). Imagery from the real-world and the computer-generated are combined and presented to a user such that they appear to share the same physical space.

### SUMMARY

Described herein is a system for providing a response within an augmented reality session, comprising: a computer comprising a processor and a memory having computer-executable instructions stored thereupon which, when executed by the processor, cause the computer to: receive positional data information regarding at least a portion of a human skeleton; identify a real world gesture based, at least in part, upon the received positional data; determine a response based, at least in part upon, the identified real world gesture; and cause the determined response to be performed in the augmented reality session.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for providing a response within an AR session.

FIG. 2 is a functional block diagram that illustrated system for providing a response within an AR session.

FIGS. 3 and 4 are exemplary user interfaces.

FIG. 5 is a flow chart that illustrates a method of providing a response to a real world action in an AR session.

FIG. 6 is a flow chart that illustrates a method of providing a response of a virtual character within an augmented reality session.

FIG. 7 is a flow chart that illustrates a method of providing a response within an augmented reality session.

FIG. 8 is a flow chart that illustrates a method of providing a response within an augmented reality session.

FIG. 9 is a functional block diagram that illustrates an exemplary computing system.

### DETAILED DESCRIPTION

Various technologies pertaining to providing a response (e.g., of a virtual character) to a real world action in an augmented reality session are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding providing a response (e.g., of a virtual character) to a real world action in an augmented reality session. What follows are one or more exemplary systems and methods.

Aspects of the subject disclosure pertain to the technical problem of providing a response (e.g., of a virtual character) to a real world action (e.g., gesture) in an augmented reality session. The technical features associated with addressing this problem involve receiving positional data information regarding at least a portion of a human skeleton; identifying a real world gesture based, at least in part, upon the received positional data; determining a response to the identified real world gesture (e.g., of a virtual character) based, at least in part upon, the identified real world gesture, for example, by mapping the identified real word gesture to a particular response (e.g., action, simulated emotion, change of appearance) of the virtual character; and causing to perform the determined responsive action in the augmented reality session. Accordingly, aspects of these technical features exhibit technical effects of more efficiently and effectively presenting an augmented reality game thus saving computing resource(s) and/or bandwidth.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

“User gaming device” refers to a moveable individual computing device including, for example, a mobile phone, a laptop, a tablet, a phablet, a personal digital assistant (“PDA”), an e-reader, a wearable computer, a head-mounted display (HMD), or any other moveable computing device having components for displaying and/or interacting with an augmented reality game (e.g., session). A “real object” is one that exists in an AR participant's surroundings. A “virtual object” is a computer-generated construct that does not exist in the participant's physical surroundings, but may be experienced (e.g., seen, heard, etc.) via the AR technology. A “virtual character” such as an avatar of an AR video game player is an example of a virtual object.

AR systems such as video games display real world (e.g., physical world) images overlaid with a virtual experience (e.g., interactive three-dimensional object(s)). An AR system thus enables a participant to view real-world imagery in combination with context-relevant, computer-generated imagery.

Described herein is a system and method for providing a response (e.g., of a virtual character) to a real world action (e.g., gesture) in an AR session (e.g., AR game). Information regarding a real world action (e.g., gesture) of a person is received by a user gaming device. Based, at least in part, upon the received information, a gesture associated with the real world action (e.g., gesture) can be identified (e.g., selected from a library of predefined gestures). Based, at least in part, upon the identified gesture, a response (e.g., action of the virtual character) can be determined (e.g., selected from a library of predefined responses). The determined response (e.g., action of virtual character) can be performed in the augmented reality session.

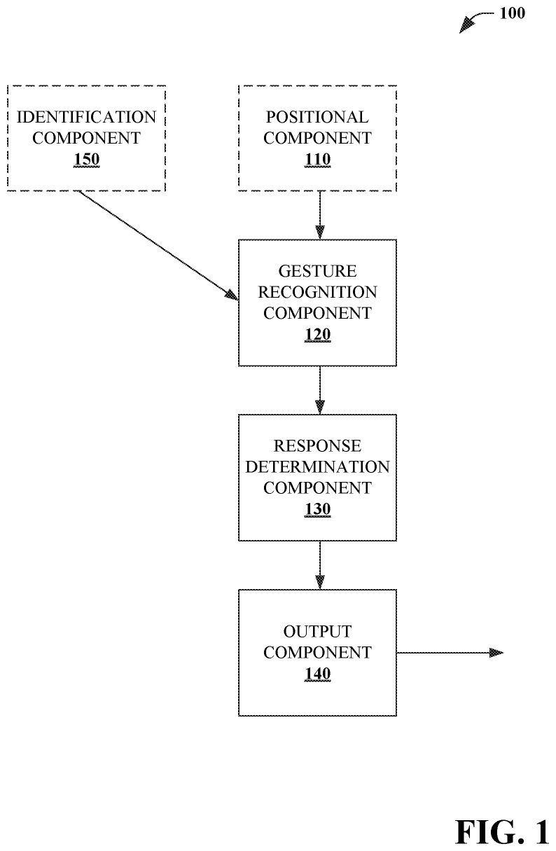

Referring to FIG. 1, a system for providing a response within an AR session 100 is illustrated. In some embodiments, the system 100 is a component of a user gaming device (not shown). In some embodiments, component(s) of the system 100 are resident on the user gaming device while other component(s) of the system 100 are resident on a cloud-based AR session system (not shown).

The system 100 includes a positional component 110 that provides positional data information regarding at least a portion of a human skeleton. In some embodiments, the positional data information comprises coordinates of where portion(s) of the human skeleton are located at particular times. In some embodiments, the positional data information is received from another component (not shown) of the user gaming device based upon received sensor input (e.g., rear-facing camera and/or front-facing camera).

In some embodiments, the positional data information regarding at least a portion of human skeleton comprises data of a user of the user gaming device of the AR session. Thus, using the system 100, gesture(s) of user can cause a response within the AR session. For example, a user a smile gesture by a user can cause a virtual character to respond by dancing or moving happily in the AR session.

In some embodiments, the positional data information regarding least a portion of human skeleton comprises data of another user (e.g., another player) of the AR session (e.g., another player of a multiplayer AR video game). In some embodiments, the positional data information regarding least a portion of human skeleton comprises data of non-player of the AR session.

The system 100 includes a gesture recognition component 120 that identifies a real world gesture based, at least in part, upon the received positional data. In some embodiments, the gesture recognition component 120 can predict human pose(s) in accordance with predicted human feature(s) (e.g., 17 joints/aspects of human body).

In some embodiments, the gesture recognition component 120 can determine that a change in location of a particular human body part (e.g., change of human pose) over a particular period of time (e.g., less than a predefined threshold time) comprises a gesture. For example, received positional data indicating movement of a left hand from a first position to a second position in less than one second can be identified as a “hand waving” gesture. In some embodiments, the gesture recognition component 120 can recognize facial gesture(s), for example, a smile, a frown, a wink, etc.

In some embodiments, the gesture recognition component 120 can be can include a classifier trained to recognize a plurality of real world gestures. In some embodiments, the classifier employs one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm. The classifier can be trained in an unsupervised, semi-supervised or supervised manner.

The system 100 further includes a response determination component 130 that determines a response based, at least in part, upon the identified real world gesture. In some embodiments, the responses to a set of gestures is predefined (e.g., by an entity associated with the AR session). For example, a “wave” action is provided in response to a received “wave” gesture.

In some embodiments, the response comprises an action or movement of a virtual character in the AR session. In some embodiments, the response comprises a simulated emotion of the virtual character (e.g., blushing, anger, happiness, joy) in the AR session. In some embodiments, the response comprises an alteration of a color, a size, and/or a visual appearance of the virtual character in the AR session. In some embodiments, the response comprises an audible sound associated with the virtual character. In some embodiments, the response comprises an audible sound in proximity in the AR session (e.g., in proximity to the virtual character). In some embodiments, the response comprises an animation (e.g., two-dimensional and/or three-dimensional) (e.g., fireworks exploding above the virtual character, a heart animation or image displayed above the virtual character) displayed in proximity to the virtual character in the AR session.

In some embodiments, determination of which response maps to a particular gesture is user-configurable. For example, a user can determine that a “two handed wave” is to be provided as a response to a “wave” gesture which response(s) map to particular gesture(s), while a “two arms up movement” is to be provided as a response to a “thumbs up” gesture. The response determination component 130 can store this user-configurable information for use in determining a response to a particular identified gesture.

The system 100 includes an output component 140 that causes the particular response to be performed (e.g., displayed) in the augmented reality session. In some embodiments, the response is performed in the direction of the received gesture as viewed in the AR session. For example, in response to a wave gesture, the virtual character can respond with a responsive wave directed towards the person gesturing by waving.

In some embodiments, the AR session can comprise a multiplayer shared coordinate video game. A virtual character can be viewable by each player's gaming device in accordance with a location and orientation of the particular player's gaming device. That is, one user gaming device may display a view of the virtual character from a first perspective (e.g., front) while another user gaming device may display a view of the virtual character from a second perspective (e.g., side). The response of the virtual character (or other action within the AR session) will likewise be viewable via the particular user gaming device based on the perspective of the particular user gaming device (e.g., based upon location and/or orientation of particular user gaming device).

In some embodiments, the system 100 includes an identification component 150 that receives identification information regarding a person associated with the at least a portion of a human skeleton. The response determination component 130 can utilize this information to determine a response. That is, the determined response can be based, at least in part, upon the identified real world gesture and the received identification information. In this manner, when a first person (user's sibling) performs a particular gesture (wave), the virtual character can be caused to respond in a first manner (wave back). However, when a particular second person (user's significant other) performs the particular gesture (wave), the virtual character can be caused to respond in a different second manner (e.g., excited jumping).

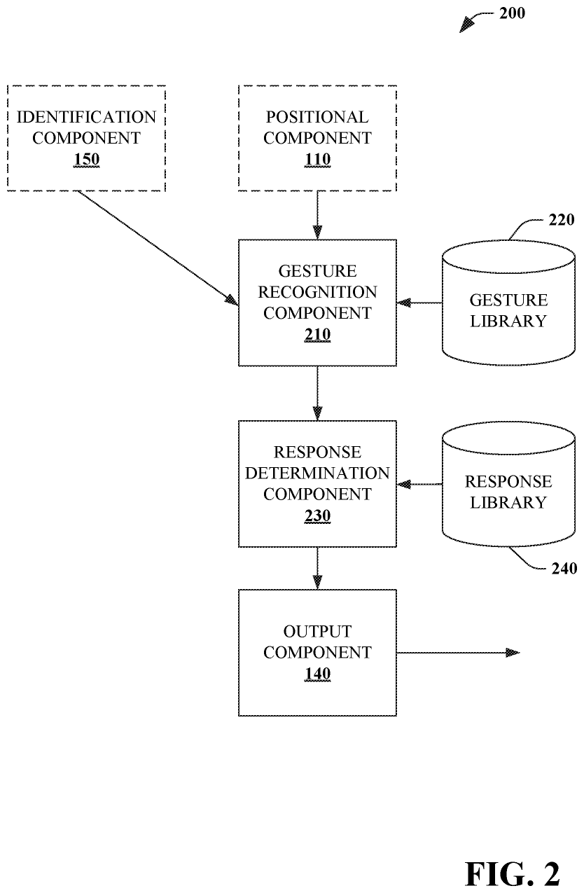

Turning to FIG. 2, a system for providing a response within an AR session 200 is illustrated. The system 200 includes the positional component 110, and, the output component 140, as discussed above.

The system 200 includes a gesture recognition component 210 that identifies a real world gesture based, at least in part, upon the received positional data. However, the identified gestures are limited to a predefined set of gestures stored in a gesture library 220. Thus, the identified real world gesture is identified based, at least in part, upon the received positional data, and, the stored predefined gesture information.

In some embodiments, the predefined set of gestures is determined by an entity associated with an AR video game (e.g., owner, manufacturer, licensee). In this manner, the entity can set forth which gestures will be recognized in the AR video game. In some embodiments, the predefined set of gestures available for a particular user gaming device can be based upon criteria specified by the entity (e.g., game experience level, payment, specific active participant(s) in the AR session, quantity of active participant(s) in the AR session). Thus, the predefined set of gestures available for a first user gaming device can be different than the predefined set of gestures available for a second user gaming device.

The system further includes a response determination component 230 that determines a response based, at least in part, upon the identified real world gesture, and, a response library 240 storing a plurality of predefined responses. In some embodiments, the predefined responses are determined by an entity associated with an AR video game (e.g., owner, manufacturer, licensee). In this manner, the entity can set forth which responses will be allowed to be performed in the AR video game. Thus, in some embodiments, no user-generated response(s) are permitted to be stored and/or performed.

In some embodiments, the gesture recognition component 210 can provide information to the response determination component 230 that a non-recognized gesture (e.g., unsupported gesture) has been received. In some embodiments, the response determination component 230 can determine a response to the non-recognized gesture (e.g., unsupported gesture) such as causing the virtual character to shrug its shoulders or otherwise indicate a lack of understanding, play a specific sound or sounds, display a specific symbol or animation, etc.

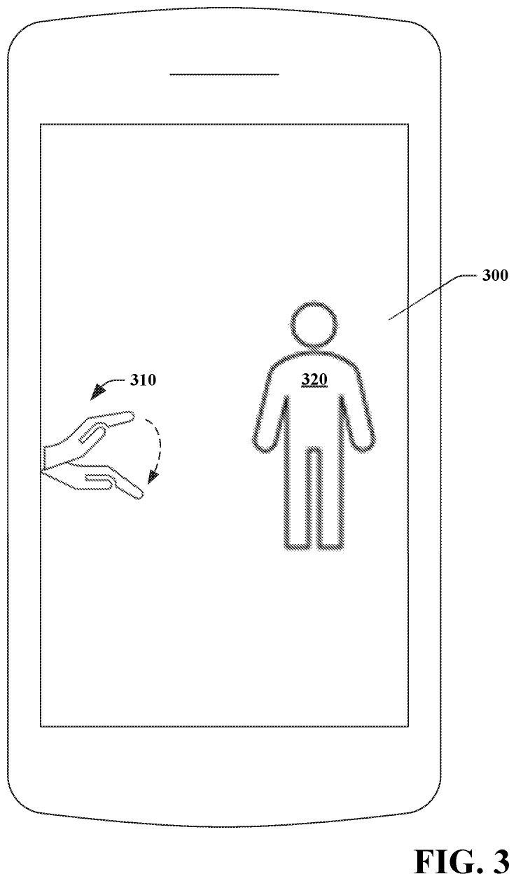

Referring to FIG. 3, an exemplary user interface 300 is illustrated. The user interface displays a real world hand 310 with a virtual character 320 in an AR session. In this example, the real world hand 310 moves from a first position to a second position which the gesture recognition component 120 identifies as a “hand wave” gesture.

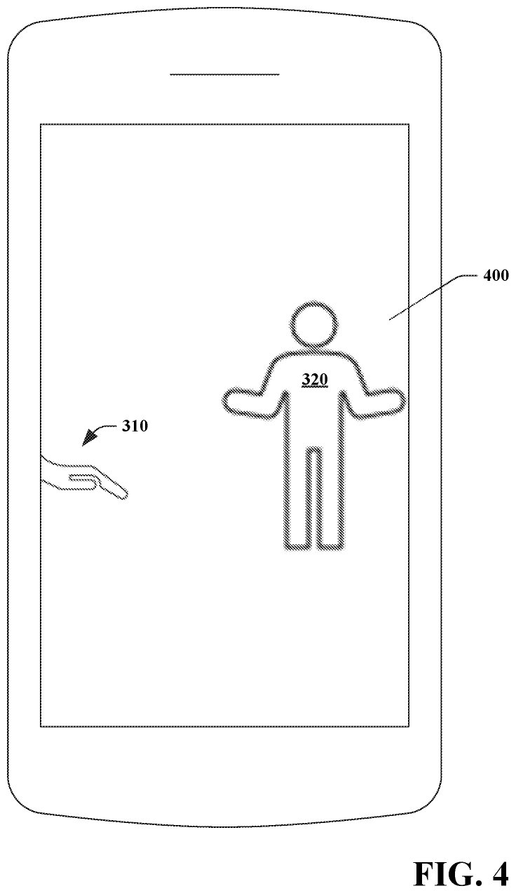

Turning to FIG. 4, an exemplary use interface 400 is illustrated. The user interface 400 includes a display of the real world hand 310. However, the user interface 400 further includes a determined response of the virtual character 320 to the “hand wave” gesture. In this example, the virtual character 320 has raised both forearms as a responsive gesture to the identified “hand wave” gesture.

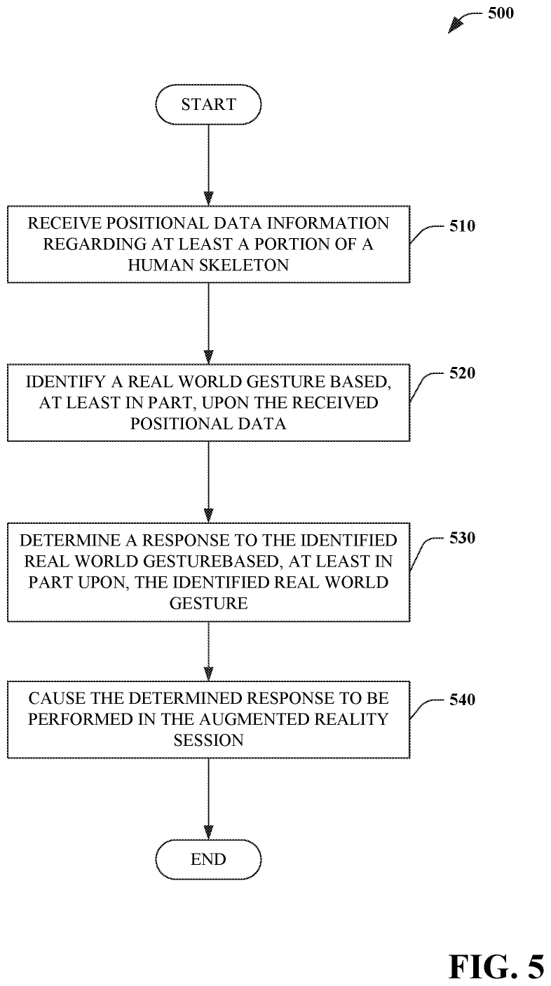

FIGS. 5-8 illustrate exemplary methodologies relating to providing a response to a real world action in an AR session. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 5, a method of providing a response to a real world action in an AR session 500 is illustrated. In some embodiments, the method 500 is performed by the system 100 and/or the system 200.

At 510, positional data information is received regarding at least a portion of a human skeleton. At 520, a real world gesture is identified based, at least in part, upon the received positional data.

At 530, a response to the identified real world gesture is determined based, at least in part upon, the identified real world gesture. For example, the identified real world gesture can be mapped to a particular response or action of a virtual character in the AR session. At 540, the particular response is caused to be performed in the augmented reality session.

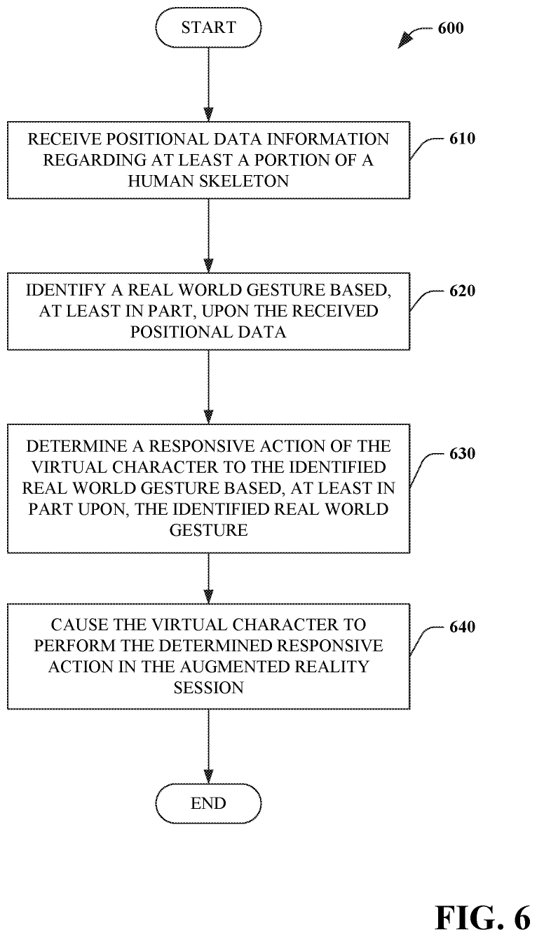

Turning to FIG. 6, a method of providing a response of a virtual character within an augmented reality session 600 is illustrated. In some embodiments, the method 600 is performed by the system 100 and/or the system 200.

At 610, positional data information regarding at least a portion of a human skeleton is received. At 620, a real world gesture is identified based, at least in part, upon the received positional data.

At 630, a responsive action of the virtual character to the identified real world gesture is determined based, at least in part upon, the identified real world gesture. At 640, the virtual character is caused to perform the determined responsive in the augmented reality session.

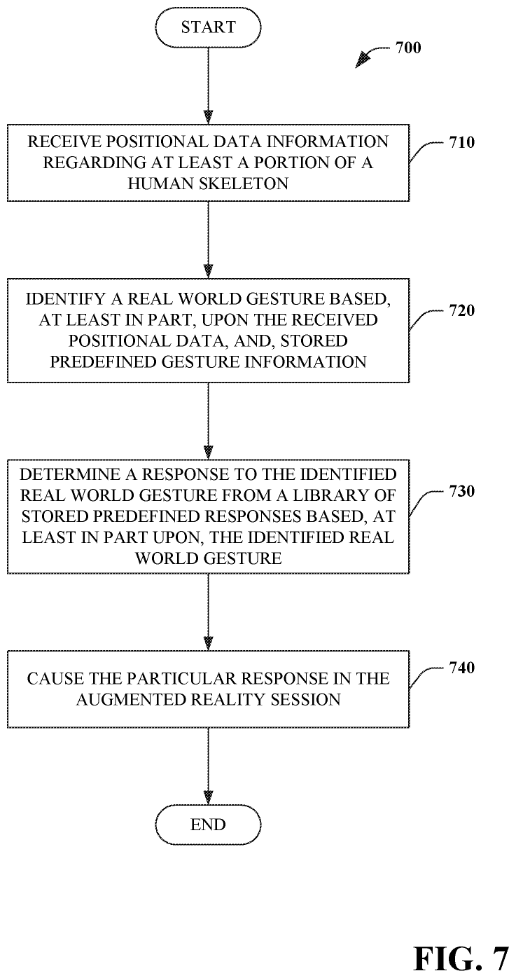

Referring to FIG. 7, a method of providing a response within an augmented reality session 700 is illustrated. In some embodiments, the method 700 is performed by the system 100 and/or the system 200.

At 710, positional data information regarding at least a portion of a human skeleton is received. At 720, a real world gesture is identified based, at least in part, upon the received positional data.

At 730, a response to the identified real world gesture is determined from a library of stored predefined responses based, at least in part upon, the identified real world gesture. At 740, the particular response is caused to be performed in the augmented reality session.

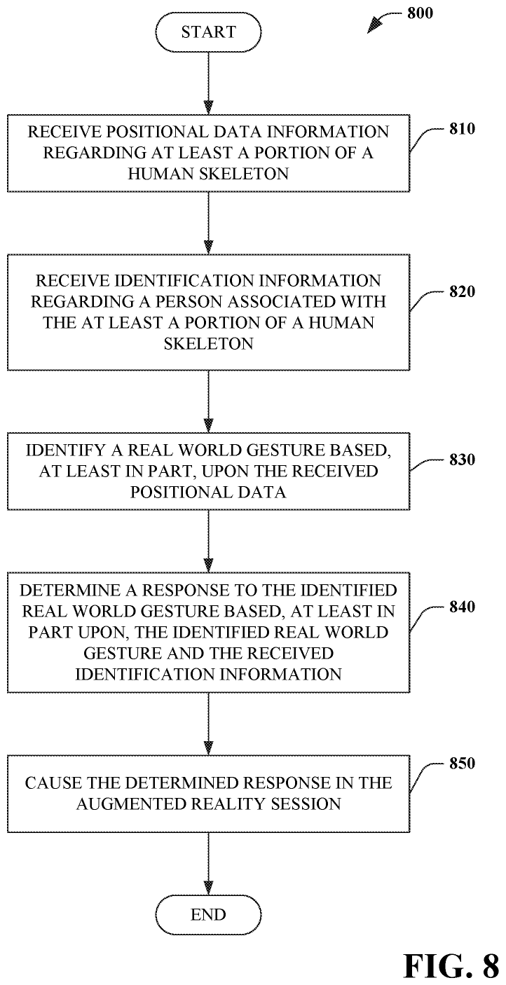

Turning to FIG. 8, a method of providing a response within an augmented reality session 800 is illustrated. In some embodiments, the method 800 is performed by the system 100 and/or the system 200.

At 810, positional data information regarding at least a portion of a human skeleton is received. At 820, identification information regarding a person associated with the at least a portion of a human skeleton is received.

At 830, a real world gesture is identified based, at least in part, upon the received positional data. At 840, a response to the real world gesture is determined based, at least in part upon, the identified real world gesture, and, the received identification information. At 840, the determined response is caused to be performed in the augmented reality session.

Described herein is a system for providing a response within an augmented reality session, comprising: a computer comprising a processor and a memory having computer-executable instructions stored thereupon which, when executed by the processor, cause the computer to: receive positional data information regarding at least a portion of a human skeleton; identify a real world gesture based, at least in part, upon the received positional data; determine a response to the identified real world gesture from a library of stored pre-defined responses based, at least in part upon, the identified real world gesture; and cause the determined response to be performed in the augmented reality session.

The system can further include wherein the determined response comprises an action of a virtual character in the augmented reality session. The system can further include wherein the determined response comprises a simulated emotion of a virtual character in the augmented reality session. The system can further include wherein the determined response comprises a change in at least one of a color, a size, or a visual appearance of a virtual character in the augmented reality session.

The system can further include wherein the determined response comprises a sound of a virtual character in the augmented reality session. The system can further include wherein the determined response comprises a sound played in proximity to a virtual character in the augmented reality session. The system can further include wherein identification of the real world gesture is further based, at least in part, upon selection from a predefined library of gestures.

The system can further include wherein determination of the response is further based, at least in part, upon a user configurable mapping between gestures and responses. The system can include the memory having further computer-executable instructions stored thereupon which, when executed by the processor, cause the computer to: receive information identifying a person associated with the positional information, wherein determination of the response is further based, at least in part, upon the received information identifying the person. The system can further include wherein a default response is determined for an unrecognized or unsupported identified gesture.

Described herein is a method of providing a response of a virtual character within an augmented reality session, comprising: receiving positional data information regarding at least a portion of a human skeleton; identifying a real world gesture based, at least in part, upon the received positional data; determining a responsive action of the virtual character to the identified real world gesture from a library of stored pre-defined responses based, at least in part upon, the identified real world gesture; and causing the virtual character to perform the determined responsive action in the augmented reality session.

The method can further include wherein the determined responsive action comprises a simulated emotion of a virtual character in the augmented reality session. The method can further include wherein the determined responsive action comprises a change in at least one of a color, a size, or a visual appearance of the virtual character in the augmented reality session. The method can further include wherein the determined responsive action comprises a sound of the virtual character in the augmented reality session.

The method can further include wherein the determined responsive action comprises a sound played in proximity to the virtual character in the augmented reality session. The method can further include wherein identification of the real world gesture is further based, at least in part, upon selection from a predefined library of gestures. The method can further include receiving information identifying a person associated with the positional information, wherein determination of the responsive action is further based, at least in part, upon the received information identifying the person.

Described herein is a computer storage media storing computer-readable instructions that when executed cause a computing device to: receive positional data information regarding at least a portion of a human skeleton; identify a real world gesture based, at least in part, upon the received positional data; determine a response to the identified real world gesture from a library of stored pre-defined responses based, at least in part upon, the identified real world gesture; and cause the determined response to be performed in the augmented reality session.

The computer storage media can further include wherein the determined response comprises an action of a virtual character in the augmented reality session. The computer storage media can further include wherein identification of the real world gesture is further based, at least in part, upon selection from a predefined library of gestures.

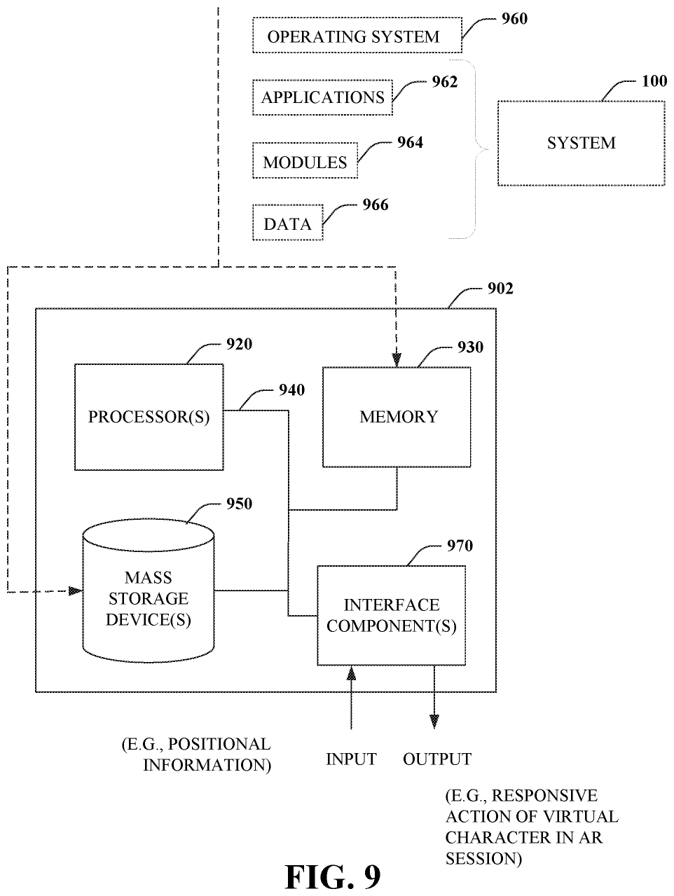

With reference to FIG. 9, illustrated is an example general-purpose computer or computing device 902 (e.g., mobile phone, desktop, laptop, tablet, watch, server, hand-held, programmable consumer or industrial electronics, set-top box, game system, compute node, etc.). For instance, the computing device 902 may be used in a system for providing a response to a real world action in an AR session 100, 200.

The computer 902 includes one or more processor(s) 920, memory 930, system bus 940, mass storage device(s) 950, and one or more interface components 970. The system bus 940 communicatively couples at least the above system constituents. However, it is to be appreciated that in its simplest form the computer 902 can include one or more processors 920 coupled to memory 930 that execute various computer executable actions, instructions, and or components stored in memory 930. The instructions may be, for instance, instructions for implementing functionality described as being carried out by one or more components discussed above or instructions for implementing one or more of the methods described above.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 920 can be a graphics processor.

The computer 902 can include or otherwise interact with a variety of computer-readable media to facilitate control of the computer 902 to implement one or more aspects of the claimed subject matter. The computer-readable media can be any available media that can be accessed by the computer 902 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 902. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 930 and mass storage device(s) 950 are examples of computer-readable storage media. Depending on the exact configuration and type of computing device, memory 930 may be volatile (e.g., RAM), non-volatile (e.g., ROM, flash memory, etc.) or some combination of the two. By way of example, the basic input/output system (BIOS), including basic routines to transfer information between elements within the computer 902, such as during start-up, can be stored in nonvolatile memory, while volatile memory can act as external cache memory to facilitate processing by the processor(s) 920, among other things.

Mass storage device(s) 950 includes removable/non-removable, volatile/non-volatile computer storage media for storage of large amounts of data relative to the memory 930. For example, mass storage device(s) 950 includes, but is not limited to, one or more devices such as a magnetic or optical disk drive, floppy disk drive, flash memory, solid-state drive, or memory stick.

Memory 930 and mass storage device(s) 950 can include, or have stored therein, operating system 960, one or more applications 962, one or more program modules 964, and data 966. The operating system 960 acts to control and allocate resources of the computer 902. Applications 962 include one or both of system and application software and can exploit management of resources by the operating system 960 through program modules 964 and data 966 stored in memory 930 and/or mass storage device (s) 950 to perform one or more actions. Accordingly, applications 962 can turn a general-purpose computer 902 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 962, and include one or more modules 964 and data 966 stored in memory and/or mass storage device(s) 950 whose functionality can be realized when executed by one or more processor(s) 920.

In some embodiments, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 902 also includes one or more interface components 970 that are communicatively coupled to the system bus 940 and facilitate interaction with the computer 902. By way of example, the interface component 970 can be a port (e.g., serial, parallel, PCMCIA, USB, FireWire, etc.) or an interface card (e.g., sound, video, etc.) or the like. In one example implementation, the interface component 970 can be embodied as a user input/output interface to enable a user to enter commands and information into the computer 902, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 970 can be embodied as an output peripheral interface to supply output to displays (e.g., LCD, LED, plasma, etc.), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for providing a response within an augmented reality session, comprising:
a computer comprising a processor and a memory having computer-executable instructions stored thereupon which, when executed by the processor, cause the computer to:
receive positional data information regarding at least a portion of a human skeleton;
identify a real world gesture based, at least in part, upon the received positional data;
determine a response to the identified real world gesture from a library of stored pre-defined responses based, at least in part upon, the identified real world gesture; and
cause the determined response to be performed in the augmented reality session.

2. The system of claim 1, wherein the determined response comprises an action of a virtual character in the augmented reality session.

3. The system of claim 1, wherein the determined response comprises a simulated emotion of a virtual character in the augmented reality session.

4. The system of claim 1, wherein the determined response comprises a change in at least one of a color, a size, or a visual appearance of a virtual character in the augmented reality session.

5. The system of claim 1, wherein the determined response comprises a sound of a virtual character in the augmented reality session.

6. The system of claim 1, wherein the determined response comprises a sound played in proximity to a virtual character in the augmented reality session.

7. The system of claim 1, wherein identification of the real world gesture is further based, at least in part, upon selection from a predefined library of gestures.

8. The system of claim 1, wherein determination of the response is further based, at least in part, upon a user configurable mapping between gestures and responses.

9. The system of claim 1, the memory having further computer-executable instructions stored thereupon which, when executed by the processor, cause the computer to:
receive information identifying a person associated with the positional information, wherein determination of the response is further based, at least in part, upon the received information identifying the person.

10. The system of claim 1, wherein a default response is determined for an unrecognized or unsupported identified gesture.

11. A method of providing a response of a virtual character within an augmented reality session, comprising:
receiving positional data information regarding at least a portion of a human skeleton;
identifying a real world gesture based, at least in part, upon the received positional data;
determining a responsive action of the virtual character to the identified real world gesture from a library of stored pre-defined responses based, at least in part upon, the identified real world gesture; and
causing the virtual character to perform the determined responsive action in the augmented reality session.

12. The method of claim 11, wherein the determined responsive action comprises a simulated emotion of a virtual character in the augmented reality session.

13. The method of claim 11, wherein the determined responsive action comprises a change in at least one of a color, a size, or a visual appearance of the virtual character in the augmented reality session.

14. The method of claim 11, wherein the determined responsive action comprises a sound of the virtual character in the augmented reality session.

15. The method of claim 11, wherein the determined responsive action comprises a sound played in proximity to the virtual character in the augmented reality session.

16. The method of claim 11, wherein identification of the real world gesture is further based, at least in part, upon selection from a predefined library of gestures.

17. The method of claim 11, further comprising:
receiving information identifying a person associated with the positional information, wherein determination of the responsive action is further based, at least in part, upon the received information identifying the person.

18. A computer storage media storing computer-readable instructions that when executed cause a computing device to:
receive positional data information regarding at least a portion of a human skeleton;
identify a real world gesture based, at least in part, upon the received positional data;
determine a response to the identified real world gesture from a library of stored pre-defined responses based, at least in part upon, the identified real world gesture; and
cause the determined response to be performed in the augmented reality session.

19. The computer storage media of claim 18, wherein the determined response comprises an action of a virtual character in the augmented reality session.

20. The computer storage media of claim 18, wherein identification of the real world gesture is further based, at least in part, upon selection from a predefined library of gestures.
